(19) United States
(12) Patent Application Publication
(10) Pub. No.: US 2005/0143050 A1
(43) Pub. Date: Jun. 30, 2005

(54) Method for billing a communications link between communications terminals

(75) Inventor: Uwe Foll, Falkensee (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/508,974

(22) PCT Filed: Mar. 13, 2003
(86) PCT No.: PCT/EP03/02657

(30) Foreign Application Priority Data
Mar. 27, 2002 (EP) 02090124.5

(51) Int. Cl. H04M 11/00

(52) U.S. Cl. 455/406

(57) ABSTRACT

The invention relates to a method for billing a communications link (KV) that is established via the internet (INET) between a first communications terminal (KEG) and a mobile target communications terminal (ZKEG) of a packet-oriented mobile radio network (MFN). According to the inventive method, from a first communications terminal (KEG), a request message (AF) relating to the communications link (KV) is guided via the internet (INET) to a node (GW) of the mobile radio network (MFN), the node determines a call charge computer (GS1) in which billing data are stored (M1), the node (GW) transmits a billing request (GA) regarding the communications link to the call charge computer (GS1), the latter checks if, on the communications terminal (KEG) end, the charges for the complete communications link are borne, and if the result of this check is positive, the communications link (KV) to the target communications terminal (ZKEG) is established in the mobile radio network (MFN).

### CLAIM FOR PRIORITY

This application is a national stage of PCT/EP03/02657, published in the European language on Oct. 2, 2003, which claims the benefit of priority to European Application No. 02090124.5, filed on Mar. 27, 2002.

### TECHNICAL FIELD OF THE INVENTION

The present invention relates to a method for billing a communications link between communications terminals.

### BACKGROUND OF THE INVENTION

To use the possibilities offered by the Internet, communications terminals (e.g. computers, laptops, PDAs or mobile phones) utilizing various technologies (e.g. dial-up telephone link, dedicated line or satellite link) are connected to the Internet. With the progressive development of mobile radio networks, of the third generation in particular (GPRS=General Packet Radio Service, UMTS=Universal Mobile Telecommunications Service), an extremely wide range of information will be transmitted in future by such communications terminals to target communications terminals (e.g. mobile phones, laptops or PDAs with a j mobile radio interface) linked to mobile radio networks. In return for the use of mobile radio resources, the operators of mobile radio networks will demand a payment, in the form of communications charges, for example.

### SUMMARY OF THE INVENTION

The present invention discloses a method with which communications links between communications terminals connected to the Internet and mobile target communications terminals can be billed in a safe and reliable manner.

In one embodiment in accordance with the invention, there is a method for billing a communications link which is established via the Internet between a first communications terminal and a mobile target communications terminal of a packet-oriented mobile radio network in which a request message relating to the communications link is routed by the first communications terminal via the Internet to a network node of the mobile radio network, a call charge computer is determined by the network node, which stores charge payment data relating to the first communications terminal, a charge request relating to the communications link is sent by the network node to the call charge computer, a check is made by the call charge computer as to whether the charges relating to the communications link at the mobile radio network end are being borne by the communications terminal, a response message containing the result of the check is sent by the call charge computer to the network node and, if the result of the check is positive, the communications link to the target communications terminal is established in the mobile radio network or, if the result of the check is negative, the establishment of the communications link in the mobile phone network is terminated.

It is particularly advantageous herein that, even before the establishment of the communications link in the mobile phone network with the target communications terminal, the call charge computer determines whether the communications terminal or the operator thereof will bear the charges that are incurred. The information required to make this observation or check can be stored in the charge payment data, the charge payment data being determined and stored for example on the basis of a contract between the operator of the communications terminal and an operator of the call charge computer. The method relates in particular to charges for the communications link at the mobile radio network end, which is understood as being that part of the communications link that is located in the mobile radio network or that generates costs in the mobile radio network.

In another embodiment according to the invention, a link node connecting the Internet to the mobile radio system is used as a network node. The link node (Gateway) thus constitutes an “input node” or “first node” of the mobile radio network. It is particularly advantageous herein that the link node already actuates the checking of the handling of the charges by the call charge computer at a time when the message requesting the establishment of the link reaches the mobile radio network for the first time.

Should the check lead to a negative result (that is, for example, to no charges being borne at the communications terminal end), then the establishment of the communications link in the mobile radio network is already terminated in the link node and advantageously there is no unnecessary strain on the resources of the mobile radio network.

In still another embodiment of the invention, an element of a data packet control system controlling the establishment of a connection is used as a network node.

In yet another embodiment according to the invention, the first communications terminal can be connected to the Internet via an Internet access network. As a result thereof, such communications terminals which are not directly connected to the public Internet but in which access to the Internet is achieved via one or a plurality of interconnected access networks can advantageously participate in the method according to the invention.

According to another embodiment of the invention, a network computer of the Internet access network can be used in the method as a call charge computer. Advantageously, a network computer of such a kind can be a computer that is available in the Internet access network anyway (for example for billing the costs between the communications terminal and an operator of the Internet access network, that is, for instance, to bill the access of the communications terminal to the Internet). As a result thereof, a separate call charge computer does not need to be installed for the method according to the invention but a network computer that is already available can be used to handle a further task. This makes it possible to achieve a very reasonably priced and low input design of the method according to the invention.

In another embodiment according to the invention, a network computer of the mobile radio network can also be used as a call charge computer. Such a development of the method according to the invention is particularly advantageous because the communication between the link node and the network computer of the mobile radio network takes place within the mobile radio network. This makes it possible to achieve a particularly secure and interception-proof data transmission, which firstly meets the high security requirements for billing methods and secondly guarantees data protection of a particularly distinctive level. The network computer can be arranged in the data packet control system, for example.

In still another embodiment according to the invention, an Internet computer on the Internet can be used as a call charge computer. Advantageously, it is possible herein to use an Internet server that is available on the Internet as a call charge computer. For the above purpose, the services of an Internet service provider can be used, for example. As a result thereof, the method can be implemented more cheaply than when a separate call charge computer is installed.

In yet another embodiment according to the invention, the information is transmitted to the network node by means of the response message, such that the charges that are incurred with respect to the communications link are borne at the first communications terminal end, call charge data relating to the charges are determined by the call charge computer, and a charge payment is effected via the call charge computer by an operator of the communications terminal to an operator of the mobile radio network. Where the method proceeds in such a way, the information that the charges incurred for the communications link are being borne at the first communications terminal end is advantageously transmitted to the link node. As a result thereof, it is advantageous to the link node that no monitoring of charges is necessary (e.g. regarding the level of charges incurred) with the result that it is guaranteed that the method will proceed simply.

In still another embodiment according to the invention, information is transmitted in the response message to the network node, the charges incurred in association with the communications link being borne at the first communications terminal end, up to a pre-set maximum level, call charge data relating to the charges are determined in the call charge computer, and a charge payment by an operator of the communications terminal to an operator of the mobile radio network is effected by the call charge computer. It is particularly advantageous here that, by monitoring the maximum level (which represents a threshold value or limit), a more extensive control of the charges can be effected.

In another embodiment, the communications link is terminated if a charge level included in the recorded call charge data reaches the maximum level. Thus it is advantageously possible to avoid the communications link being maintained if no further payment is made at the communications terminal end.

In still another embodiment, as soon as a charge level included in the recorded call charge data reaches the maximum level, an additional charge payment is effected and subsequently a fresh recording of the call charge data is commenced, starting at the zero charge level. The additional charge payment that is effected advantageously ensures that no unintentionally high call charges mount up (e.g. through very long communications connections).

In yet another embodiment according to the invention, in the response message, information is transmitted to the network node stating that a proportion of the charges incurred with respect to the communications link are being borne by the first communications terminal, call charge data relating to said proportion of the charges are determined by the call charge computer, and a call charge payment is effected via the call charge computer by an operator of the communications terminal to an operator of the mobile radio network. Where the method proceeds in such a way, this advantageously creates the opportunity for a communications terminal to bear only a proportion of the communications charges (e.g. 50%). The remaining part of the call charges can then be borne by the target communications terminal, for example, or even by the operator of the Internet access network.

In another embodiment according to the invention, further call charge data can be recorded in a memory of the mobile radio network, in order to check call charge payment procedures during the charge payment that has been effected, by comparing the call charge data recorded in the call charge computer and the further call charge data recorded in the memory of the mobile radio network. Advantageously, the security of the call charge payment procedure is clearly enhanced as a result thereof since, by comparing the call charge data, communications errors, an erroneous data transmission or even fraudulent attempts at manipulation can be detected, for example.

In still another embodiment according to the invention, when the call charge payment is effected, the charges can be divided between the operator of the call charge computer and an operator of the mobile radio network. Advantageously, one payment of the amount charged then has to be paid at the communications terminal, while the division of the amount charged between the two operators is effected internally within the procedure, with the result that no additional expense is incurred for the communications terminal in relation to the division.

In yet another embodiment according to the invention, before the response message is transmitted by the call charge computer, the transmission to the first communications terminal of an information message relating to the call charges is effected, the receipt of the information message is confirmed by the first communications terminal by means of a confirmation message, and after the confirmation message has been received by the call charge computer, the response message is transmitted to the network node. It is advantageous herein that the communications terminal is informed of the intended establishment of a communications link before the link is established. Since the establishment of the communications link is effected after the confirmation message has been received (which can constitute consent to the establishment of a communications link), an unintentional or erroneous establishment of a communications link (associated with unnecessary strain on resources) can be safely avoided.

The aforementioned embodiment can also be supplemented in that a proceed-to-dial relating to the charges is transmitted to the first communications terminal with the information message, a selection is made by the first communications terminal in response to the proceed-to-dial and information regarding the selection that has been made is transmitted to the call charge computer in the response message. Advantageously, as a result thereof, the opportunity is provided for a communications terminal to choose between various alternatives relating to the communications link. Such alternatives can be provided, for example, by various sets of call charges that are to be applied. However, one alternative would, for example, be the termination of the procedure in order to avoid communications charges.

### BRIEF DESCRIPTION OF THE DRAWINGS

The invention is explained in more detail below with reference the exemplary embodiments illustrated in the drawings, in which:

FIG. 1 shows an exemplary embodiment of sequences according to the invention.

FIG. 2 shows an exemplary embodiment of the invention.

FIG. 3 shows an exemplary embodiment according to the invention.

### DETAILED DESCRIPTION OF THE INVENTION

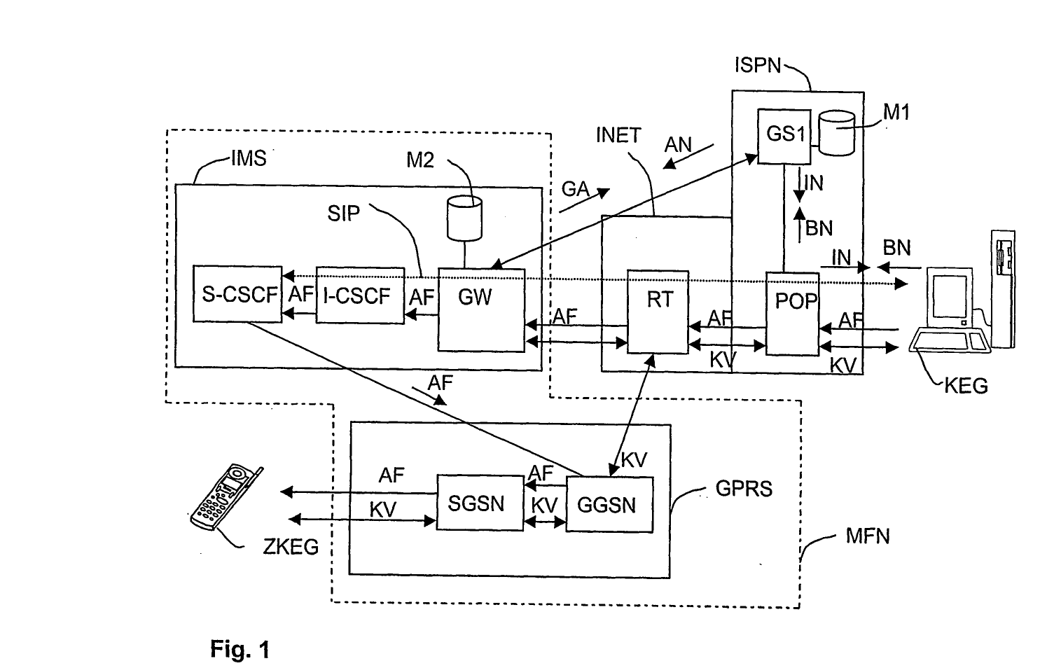

The right-hand side of FIG. 1 shows a communications terminal KEG in the form of a computer (for example, a personal computer). Said communications terminal KEG is connected to an Internet access network ISPN (ISPN=Internet Service Provider Network) of an ISP (ISP=Internet Service Provider). The Internet access network ISPN for its part is connected to the Internet INET. One single switching processor RT (RT=Router) of the Internet INET is shown in the diagram. There are, of course, a large number of further switching processors on the Internet and Internet computers connected to said further switching processors. A section of a mobile radio network MFN connected to the Internet is shown in a schematic representation. Said section contains a data packet control system IMS (IMS=IP Multimedia Subsystem, IP=Internet Protocol). The data packet control system IMS is connected to a GPRS data transmission system. The exemplary embodiment shows a mobile radio network of the third generation which operates according to GPRS defaults (GPRS=General Packet Radio System). Finally, a target communications terminal ZKEG connected to a mobile radio network MFN is shown; in the present case it is a mobile phone.

A data packet control system IMS ensures general packet-based multimedia control for mobile communications networks. The control system IMS makes it possible to provide multimedia services both for mobile access networks and for the Internet. The control functions are effected using a protocol known as the “Session Initiation Protocol” (SIP). The generic protocol can be used in control functions both to control the establishment of a link by subscribers within the mobile radio network and the establishment of a link between the mobile radio network's subscribers and Internet subscribers. The control of the connections is effected herein using a “Call State Control Function” (CSCF), which constitutes a component of the IMS control system.

A communications link is now to be established between the communications terminal KEG and the target communications terminal ZKEG. To this end, the communications terminal transmits a set-up request message AF, which is routed to a mobile radio network MFN. The AF first arrives at an access node POP of the Internet access network ISPN. The access node POP (POP=Point of Presence) is an interface via which external terminals establish contact with the Internet access network ISPN. The set-up request message AF is redirected unchanged (transparently) by the access node POP to the Internet's INET switching processor RT.

The set-up request message AF includes information about the sender of the set-up request message AF (that is, via the communications terminal KEG), about the communications link that is to be established and about the target of the communications link that is to be established, in the present case the target communications terminal ZKEG constitutes the target of the communications link.

On the basis of the information transmitted with the set-up request message AF, the switching processor RT identifies the mobile radio network MFN that is responsible for the target communications terminal ZKEG. This can be effected via a request in a central data memory (e.g. a Domain Name Server DNS). The mobile radio network MFN can be the mobile radio network assigned to the target communications terminal ZKEG, for example. The switching processor RT redirects the set-up request message AF unchanged (transparently) to a link node GW (GW=Gateway) of the mobile radio network. Said link node GW constitutes a communications interface between the mobile radio network MFN and the Internet, INET. In the present case, the link node GW constitutes an element of the IMS data packet control system that controls the establishment of the communications link.

The link node GW detects from the set-up request message AF that a communications link is to be set up between the communications terminal KEG and the target communications terminal ZKEG. The communications terminal KEG is identified herein as the sender of the set-up request message AF, that is, as the initiator of the communications link. The link node likewise detects that the set-up request message AF was transmitted via the Internet INET; that is, that the communications request originated from the Internet. It is therefore known that the communications link is to be set up via the mobile radio network MFN from a communications terminal KEG that is connected to the Internet INET via the Internet INET to the target communications terminal ZKEG. The link node GW now determines which call charge computer is responsible for the communications terminal KEG. Said determination of a call charge computer can be effected in various ways:

1. A list of known call charge computers is stored in the link node GW. The call charge computer responsible for the communications terminal KEG is found by evaluating sender information from the communications terminal KEG (which information was transmitted along with the set-up request message AF, for instance the IP address of the computer KEG).

2. The link node issues a request to a central address server (for instance to the server DNS; DNS=Domain Name Server) on the public Internet, quoting the sender information from the communications terminal KEG; the address of the call charge computer responsible is then transmitted by the central address server.

3. The address of the call charge computer responsible is transmitted to the link node GW by means of a message set up according to the session initiation protocol SIP (e.g. for the SIP message INVITE).

4. The link node GW interrogates the Internet access network ISPN as to which call charge computer is responsible; the Internet access network ISPN subsequently transmits the desired address to the link node GW.

In the case of the first communications terminal KEG, the call charge computer is a central unit, i.e. as a rule there is a call charge computer KEG responsible for each communications terminal. In contrast thereto, there can be a plurality of various link nodes GW for each communications terminal KEG. Which link node is used in the respective individual case may then depend on the route used by the communications terminal to make a link with the mobile radio network.

The link node GW now determines the address of the call charge computer GS1 that is responsible in the present case, using for example the method mentioned above under point 1. The call charge computer GS1 is connected to the Internet access network ISPN or represents a part of said access network. Stored in the call charge computer GS1 or in a first memory M1 that is connected to said call charge computer GS1 is payment information relating to the communications terminal KEG. The above information relates to how and whether communications charges for communications connections that are to be set up in a mobile radio network are being handled at the communications terminal end KEG. For example, it may have been established in a contract made even before the commencement of the procedure between an operator of the communications terminal and an operator of the Internet access network that the communications charges that are incurred when communications connections are set up will be borne and paid for by the communications terminal KEG. An extremely wide range of possibilities are conceivable for the actual payment procedure in the above set-up. For example, at the end of a billing period, an invoice can be sent in each case to the operator of the communications terminal KEG, whereupon said operator pays collectively all the charges that are incurred. In this case it would be a matter of so-called post-paid billing. The charges can also be billed according to a so-called pre-paid method. For the pre-paid method, a credit account for the communications terminal KEG would be set up on the call charge computer GS1, for example, and information about a pre-paid credit amount would be stored in the above credit account. Communications charges that are incurred for communications connections could then be debited from the credit account as soon as they are incurred (online, in real time). In addition to the above examples for the actual payment procedure, all the further conceivable payment variants are applicable, for example, banks or credit card organizations can be used for this purpose.

The link node GW now issues a charge request GA to the computer GS1 that has been detected. By means of the charge request message GA, a request is sent to the call charge computer GS1 inquiring whether information about the manner of charge handling (e.g. charge payment) in the communications terminal KEG is available in the call charge computer GS1. The call charge computer GS1 now reads, from the charge payment data stored in the first memory M1 for example, that the communications terminal KEG is bearing the charges that are incurred in relation to the communications connections. Thus the call charge computer GS1 establishes that charges relating to the whole communications link KV are borne by the communications terminal KEG. The above information is transmitted back to the link node GW by means of a response message AN. On the basis of the response message AN (which represents a positive result of the check by the call charge computer GS1), the link node GW now initiates the further complete establishment of the communications link KV in the mobile radio network right up to the target communications terminal ZKEG.

In a further exemplary embodiment, however, a further method procedure that differs from the procedure that is described can be effected:

After the charge request GA has been received, the call charge computer GS1 interrogates its database M1 with respect to the communications terminal KEG. No charge payment data relating to the communications terminal KEG are stored in the database M1, however. The call charge computer GS1 subsequently transmits an information message IN via the access node POP to the communications terminal KEG. The information message IN includes information relating to the communications link KV and/or to charges relating to said communications link KV. After receipt of the information message IN together with the information transmitted, a text can be displayed, on a screen window of the computer KEG for example, in the following form: “Establishment of a link to the mobile phone having the phone number 0049 0171 1234567. What would you like to do?

1. Set up the link: flat rate charge 10 Euro.

2. Set up the link: volume-related price 0.50 Euro per MB.

3. Terminate the link.”

A selection can then be made by the communications terminal KEG in response to the above proceed-to-dial. The above procedure can also occur automatically using the defaults stored in the communications terminal. The above selection can also be effected, however, following a keyboard entry at the communications terminal KEG, for example. Information relating to the selection that has been made is subsequently transmitted back via the access node POP to the call charge computer GS1 by means of a confirmation message BN. The call charge computer GS1 stores the information about the selection that has been made and further transmits said information by means of a response message AN to the link node.

A further embodiment of the method according to the invention can provide for the contents of the information message IN to be stored by the communications terminal KEG for subsequent further processing (for example in a log file) and subsequently for a confirmation report BN to be sent back immediately to the call charge computer GS1. The call charge computer GS1 subsequently further transmits the response message to the link node GW.

The process steps described with respect to the information message IN and the confirmation message BN can also be effected, of course, if charge payment data are stored in the call charge computer GS1.

In the aforementioned variations, the (positive) check result from the call charge computer GS1 is available in the link node GW; the link node GW now effects the further establishment of a communications link KV within the mobile radio network. To this end, the link node GW further transmits the set-up request message AF to a first I-CSCF control unit (I-CSCF=Interrogating Call State Control Function). The first I-CSCF control unit determines a second S-CSCF control unit (S-CSCF=Serving Call State Control Function) that is responsible for the communications link, and further directs the set-up request message AF unchanged to the second S-CSCF control unit. The second control unit S-CSCF now determines which switching center in the mobile radio network MFN is responsible for the establishment of the communications link between the communications terminal KEG and the target communications terminal ZKEG. After a first switching center GGSN of the mobile radio network has been determined by the second control unit S-CSCF as being the switching center responsible, the second control unit S-CSCF transmits the set-up request message AF via said first switching center GGSN, via a second switching center SGSN in the conventional manner to the target communications terminal ZKEG. It is now known, both in the target communications terminal ZKEG and in the communications terminal KEG, that the communications link KV between the two terminals is to be established. A communications link is subsequently established in the conventional manner to the target communications terminal ZKEG by the communications terminal KEG via the access node POP, the switching processor RT, the first switching center GGSN and the second switching center SGSN. Random data can now be transmitted via said communications link KV. Said data can be voice data such as VoIP packets (VoIP=Voice over IP), e-mail-data, image data, film data or sound data. Call charge data generated during data transmission (e.g. data on the duration or data transmission time or data capacity of the data transmitted) are recorded in the call charge computer GS1 (in this case, therefore, recorded in the Internet access network ISPN). With the aid of the call charge data, a reversal billing acceptance from the operator of the communications terminal KEG is effected either immediately (in the case of the pre-paid billing method) in favor of the mobile radio network MFN or later (in the post-paid billing method) Optionally, further call charge data relating to the communications link KV can be recorded and stored in a memory unit of the mobile radio network (for example in a second memory M2). Using the further call charge data, a comparison can be made, during the reversal billing acceptance/charge payment that has been effected, between the call charge data recorded in the call charge computer and the call charge data recorded in the memory of the mobile radio network. It can be determined by means of the comparison whether the charge payment is being handled correctly. If differences emerge between the call charge data and the further charge data, then an error handling procedure can be effected.

In detail, the charge payment can progress in such a way that the call charge computer GS1 transmits a single charge payment message to the communications terminal KEG, whereupon the communications terminal KEG makes a single charge payment to an operator of the call charge computer GS1. The call charge computer GS1 can divide up the call charges that are thus obtained, e.g. a proportion of the amount charged can remain with the operator of the call charge computer GS1 and another proportion of the amount charged can be passed on to the operator of the mobile radio network MFN.

If information has been sent by means of the response message AN to the GW link node, stating that a proportion of the charges that are incurred is being borne at the first communications terminal end KEG, then call charge data relating to said proportion of the call charges are recorded and stored by the call charge computer GS1; accordingly a charge payment that includes said proportion of the call charges is effected by the call charge computer KEG.

The method can, however, also operate in such a way that information is sent, by means of the response message AN, to the link node GW, stating that those charges that do not exceed a maximum level will be borne at the first communications terminal end KEG. The call charge computer then records the call charge data for charges up to said maximum level. If the given charge limit is reached, then the call charge computer initiates an (unscheduled) charge payment, then resets a charge counter used to record the data and begins a “fresh” recording of the charges that are now incurred. As a further alternative, the communications link can also be terminated when the maximum charge level has been reached.

In the embodiment described above in conjunction with FIG. 1, the charges relating to the communications link KV are therefore effected by the call charge computer GS1 of the Internet Service Provider ISP.

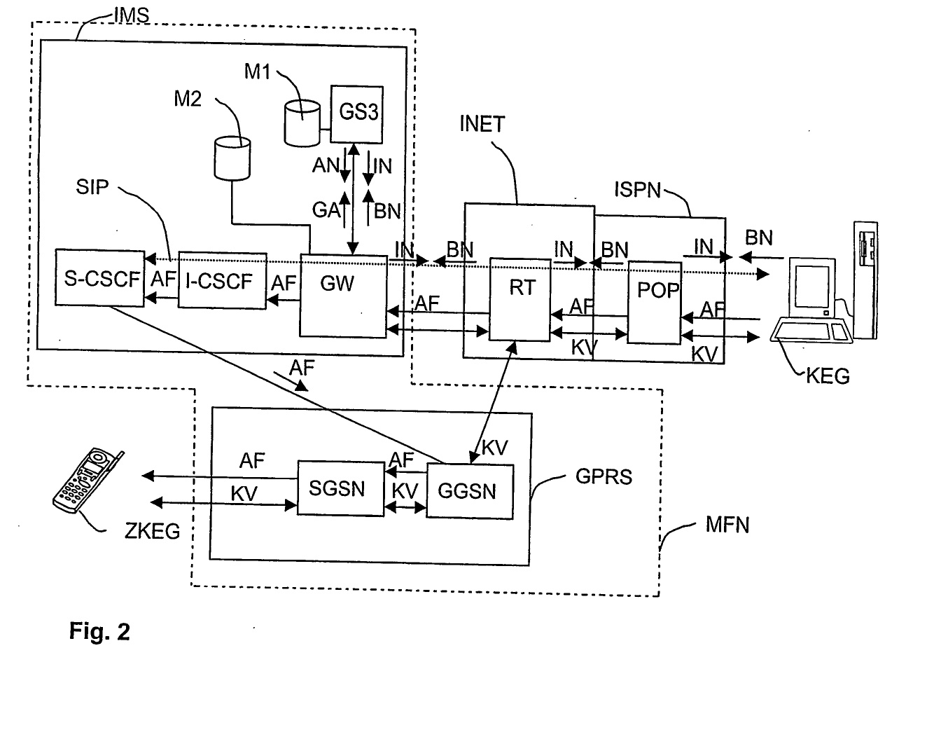

FIG. 2 shows a further exemplary embodiment, in which the charges are effected by a network computer GS3 of the mobile radio network MFN. The network computer GS3 therefore constitutes a call charge computer, which is configured in the mobile radio network MFN and is connected to the link node GW of the mobile radio network MFN. This has the advantage that the communication between the link node GW and the call charge computer GS3 operates wholly within the mobile radio network MFN, thus guaranteeing a particularly secure data transmission between the two mobile radio network elements. In contrast to the exemplary method that is explained in FIG. 1, the charge request GA is transmitted internally within the mobile radio network by the link node GW to the network computer GS3. The network computer GS3 likewise transmits the response message AN internally within the mobile radio network back to the link node GW. The call charge computer GS3 transmits the information message IN via the link node GW, the switching processor RT, the access node POP to the first communications terminal KEG; the first communications terminal KEG transmits the confirmation message BN via the access node POP, the switching center RT and the Gateway node GW back to the Internet computer GS3 that is acting as a call charge computer.

The further process correspond to those explained in association with FIG. 1. The above embodiment of the invention has the advantage that the communications link is carried out within the mobile radio network MFN; no “outside” network units (such as, for example, the call charge computer GS1 in FIG. 1) should be burdened with billing tasks. Moreover, data transmissions encroaching outside the network (between the mobile radio network MFN and the Internet access network ISPN) can be avoided; thus costs can be avoided.

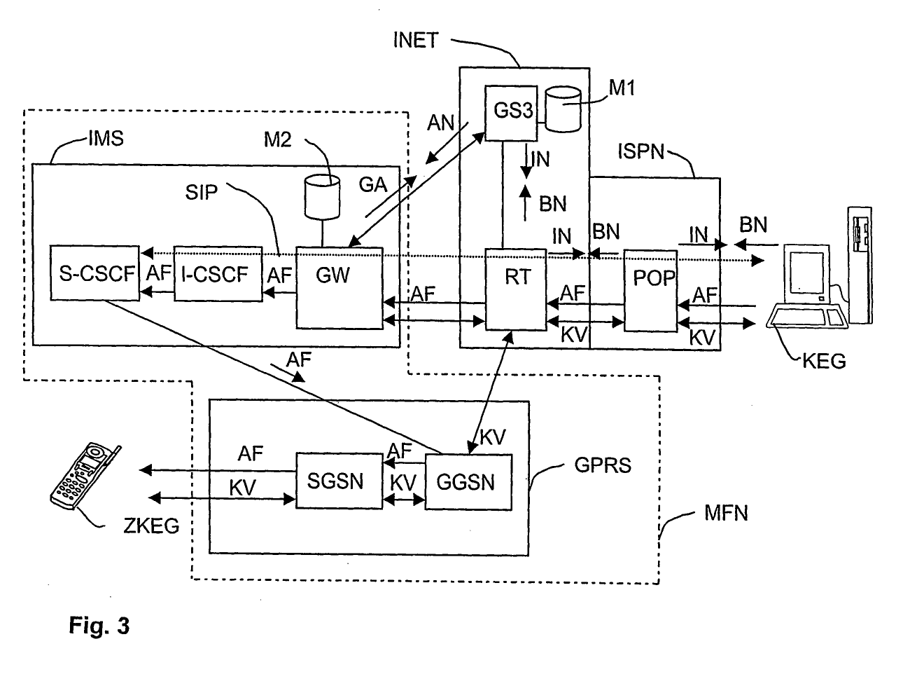

FIG. 3 shows a further exemplary embodiment according to the invention. In this example, an Internet computer GS2 on the Internet is used as a call charge computer. The Internet computer GS2 can be, for example, operated by an Internet service provider that offers its billing services to a very wide range of customers. In contrast to the process steps described in association with FIG. 1, the link node GW transmits the charge request GA to the Internet computer GS2 on the Internet INET; from the Internet INET the response message AN is sent back to the link node GW of the mobile radio network. The Internet computer GS2 transmits the information message IN via the switching processor RT and the access node POP to the first communications terminal KEG; in analogy thereto, the confirmation message BN is sent back by the first communications terminal KEG via the access node POP and the switching processor RT to the Internet computer GS2. The further process steps correspond with the process steps explained in association with FIG. 1.

In this exemplary embodiment, the address of the call charge computer GS2 is transmitted by the first communications terminal KEG to the link node GW.

In the method that has been described it is particularly advantageous that the kind of communications network or access network to which the target communications terminal is connected is taken into account when billing for the communications link. If the target communications terminal is linked to a mobile radio network, then the method operates as described and the “Internet user” in the form of the first communications terminal takes (at least partial) responsibility for the charges for the use of the resources of the mobile radio network. Advantageously, this functions even if the first communications terminal is not linked directly to the Internet and the mobile radio network, but via access- or intermediate networks. If, however, the target communications terminal is a different communications terminal that is, for example, directly connected to the Internet (not shown in the figures), then the set-up request message is directly routed via the Internet to the other communications terminal without a link node of the mobile radio network or a call charge computer being involved. In this case, the usual (e.g. time- or volume-dependent) Internet access charge is charged to the communications terminal.

The set-up request message AF is transmitted using the SIP protocol via a signaling system that controls the setting-up of the communications link. For this reason, both the communications terminal KEG and the target communications terminal ZKEG have a unit (a so-called SIP client) that enables SIP messages to be transmitted and processed.

Advantageously, information relating to the billing method can be transmitted in the headers of the SIP messages (SIP headers).

A method for billing a communications link has been described wherein the communications link is established from a starter communications terminal via the Internet to a target communications terminal in a mobile radio network. At a point in the target communications network, at the link node GW, the chargeability of the communications link is detected and a link to a call charge computer responsible for the starter communications terminal is set up. This allows billing of even such communications links that are optionally set up via a plurality of access networks or intermediate networks and via the public Internet to a target communications terminal of a mobile radio network.

1. A method for billing a communications link established via an Internet between a first communications terminal and a mobile target communications terminal of a packet-oriented mobile radio network, comprising:
routing a set-up message relating to the first communications link by the first communications terminal via the Internet to a network node of the mobile radio network, the network node determining a call charge computer, wherein charge payment data relating to the first communications terminal are stored;
transmitting a charge request relating to the communications link is transmitted by the network node to the call charge computer;
performing a check by the call charge computer, as to whether the charges relating to the communications links at the mobile radio network end are being borne at the communications terminal end; and
sending a response message, including a result of the check, is sent to the network node by the call charge computer, wherein
if there is a positive result for the check in the mobile radio network, the communications link to the target communications terminal is established, or if there is a negative result for the check in the mobile radio network, the establishment of the communications link is aborted.

2. The method according to claim 1, wherein a link node connecting the Internet to the mobile radio network is used as a network node.

3. The method according to claim 1, wherein an element of a data packet control system that controls the establishment of the link is used as a network node.

4. The method according to claim 1, wherein the first communications terminal is linked to the Internet via an Internet access network.

5. The method according to claim 4, wherein a network computer of the Internet access network is used as a call charge computer.

6. The method according to claim 1, wherein a network computer of the mobile radio network is used as a call charge computer.

7. The method according to claim 1, wherein an Internet computer of the Internet is used as a call charge computer.

8. The method according to claim 1, wherein via the response message, information is sent to the network node stating that the charges that are incurred in relation to the communications link are being borne at the first communications terminal end call charge data relating to the charges are recorded in the call charge computer, and
a charge payment is effected by an operator of the communications terminal to an operator of the mobile radio network.

9. The method according to claim 1, wherein
information is transmitted, by means of the response message, to the network node stating that the charges incurred with respect to the communications link are being borne at the first communications terminal end up to a pre-selected maximum level;
call charge data relating to the charges are recorded in the call charge computer, and
a charge payment is effected via the call charge computer by an operator of the communications terminal to an operator of the mobile radio network.

10. The method according to claim 9, wherein the communications link is terminated if a charge level recorded with the call charge data reaches the maximum level.

11. The method according to claim 9, wherein when a charge level recorded with the call charge data reaches the maximum level, an additional charge payment is effected and henceforth a fresh recording of the call charge data, starting at the zero charge level is effected.

12. The method according to claim 1, wherein via the response message, information is transmitted to the network node stating that a proportion of the charges that are incurred in relation to the communications link are being borne at the first communications terminal end, call charge data relating to the proportion of the charges are recorded in the call charge computer, and that
a charge payment to an operator of the mobile radio network is effected by an operator of the communications terminal through the call charge computer.

13. The method according to claim 8, wherein further call charge data are recorded in a memory of the mobile radio network to check charge payment procedures during the call charge payment that has been effected by comparing the call charge data recorded in the call charge computer with the further call charge data recorded in the memory of the mobile radio network.

14. The method according to claim 8, wherein during the call charge payment that has been effected, the call charges are divided between the operator of the call charge computer and the operator of the mobile radio network.

15. The method according to, claim 1, wherein
before the response message is transmitted by the call charge computer, the transmission to the first communications terminal of an information message relating to the call charges is effected,
the receipt of the information message is confirmed by means of a confirmation message issued by the first communications terminal, and
after the confirmation message has been received, the response message is transmitted to the network node by the call charge computer.

16. The method according to claim 15, wherein
a proceed-to-dial relating to the call charges is transmitted to the first communications terminal together with the information message, and
a selection is made by the first communications terminal in response to the proceed-to-dial, and information relating to the selection that has been made is transmitted by means of the confirmation message to the call charge computer.
